(19) United States
(12) Patent Application Publication
(10) Pub. No.: US 2014/0309856 A1
(43) Pub. Date: Oct. 16, 2014

(54) Vehicle Velocity Visual Alert System With Discrete and Unambiguous Brake and "Stopped" Status Features to Reduce Rear-End Crashes

(71) Applicant: Angela M. Willson-Quayle, Vienna, VA (US)

(72) Inventor: Angela M. Willson-Quayle, Vienna, VA (US)

(21) Appl. No.: 13/863,201

(22) Filed: Apr. 15, 2013

(51) Int. Cl. B60Q 1/44

(52) U.S. Cl. CPC B60Q 1/444
USPC 701/36

(57) ABSTRACT

The Speed-Orientation-for-Safety Lights System or (SOS Lights), designed to reduce rear-end motor vehicle crashes, is a velocity-contingent rear and interior colored-lights visual alert system which signals real-time information from a lead car to following drivers via a processor-memory-speedometer-brake configuration that shows a lead vehicle's: (1) actual and changing speeds; (2) degree of brake pressure when decelerating and (3) stationary status. The main alert device has a plurality of adjacent speed indicator lights with braking and stopped status elements. A processor memory is configured to store programming and speed and brake look-up tables associating speed ranges with activation of specific colored lights and braking speed with a brake pressure alert subsystem. The processor executes programming via the interconnectedness of the speedometer, accelerator, brake, brake pressure sensor and the main device.

### BACKGROUND OF THE INVENTION

The Speed-Orientation-for-Safety Lights System (or SOS Lights), designed for use in all motor vehicles, is a velocity visual alert system which conveys rate of speed information to following cars by means of an array of distinct, speed-denoting colored lights AND differentiates between vehicle braking and stopped status through discrete and unambiguous signals.

The universal brake light system in use on vehicles today operates in the following familiar way: when the brake pedal is pressed, the red outboard (and central high mounted stop light (“CHMSL”) brake lights are activated; conversely, when pressure is lifted off the pedal, the brake lights are deactivated. This system is limited, even flawed, because the information conveyed about the contemporaneous motion of the vehicle via the red brake lights can have more than one meaning. When the brake pedal is pressed, the message to the following driver can be either that (a) the lead vehicle is decelerating slowly; or (b) the lead vehicle is decelerating rapidly or (c) the vehicle has completely stopped. Our current brake light system does not adequately differentiate among those three distinct scenarios at the risk of temporarily confounding the driver and in turn reducing critical driver response time.

Fortunately, drivers compensate for these deficiencies in the system, whenever conditions allow, by rapidly (albeit unconsciously) drawing on external cues (e.g., if the distance between the following car whose speed remains constant and the lead vehicle decreases quickly, then the conclusion that the lead car is decelerating rapidly is an accurate driver assumption). However, the various external cues from which drivers draw roadway assertions may not be available when needed; like using an object ahead on the side of the road as a distance marker and calculating the time it takes to pass it in order to estimate one's own speed. This external cue might disappear in inclement weather or suboptimal driving conditions.

A problem arises, therefore, when visibility is compromised (due to rain, sunshine, fog, darkness). When external cues become impoverished or disappear altogether, drivers are left with only our conventional brake light system to rely on and this can leave drivers in momentary doubt as to what a lead vehicle might be doing. Brake light message ambiguity can result in a driver taking precious milliseconds to determine what is happening ahead and consequently delay a following driver's course of action. This critical loss of time can prove dangerous, even fatal, most especially in high-speed freeway driving situations when split-second maneuvers might be necessary to avoid a collision.

Another cause of rear-end crashes relates to following drivers not realizing that a lead vehicle is completely stopped due to perhaps inattention (e.g., daydreaming) or being distracted. In such incidents, a system that keeps the following driver's attention fully focused on the roadway ahead is vital.

Furthermore, all too often drivers do not allow sufficient braking distance relative to their travel speed, visibility and road conditions. Our current rear-light system does not provide contemporaneous information about a lead vehicle's consistent speed and, most importantly, speed changes. A system that reflects rearward contemporaneous velocity information of the forward-moving vehicle might well serve as a visual and continuously tangible reminder of the importance of observing adequate braking distance.

For these vitally important reasons, a more reliable rear-light system is long overdue. This is a system that: 1) makes the messages of decelerating slowly or rapidly completely unambiguous; 2) renders the signal that a vehicle is completely stopped unquestionable and 3) provides accurate and ever-changing vehicle velocity information. Such features would remove brake light message ambiguity and replace it with clarity and certainty. Furthermore, a system that keeps the following driver continuously informed of fore vehicle speed changes by use of visual and colored cues might reduce driver inattention and distractibility and improve roadway focus. All of these additional safety features would undoubtedly result in increased driver response time and by extension fewer rear-end crashes and less serious injury or loss of life.

It would be desirable, therefore, to have a velocity visual alert system that allows following drivers to know lead driver's approximate speed, the extent to which the lead driver is decelerating (slowly versus rapidly) and/or whether the lead vehicle has completely stopped. This invention provides all of those features.

### SUMMARY OF THE INVENTION

A vehicle velocity visual alert system with discrete and unambiguous brake and “stopped” status signals for use in all motor vehicles includes a speedometer that is configured to show the speed at which the motor vehicle is traveling by activating a single colored light from an array of different colored lights that span the rear of the vehicle. Each colored light represents a different speed range and only one speed-denoting colored light can be activated at a time. The speed system functions by means of a processor. The processor is connected to a memory that is configured to store programming and data structures. These data structures include a speed look-up table that place actual travel speed within a speed range and in turn activate a subsequent designated colored light. The processor is connected to the speed-denoting colored lights and is configured to execute programming by electrically connecting the speedometer with the speed range and activating a different colored light. More specifically, programming causes the processor to determine from the speedometer the present speed of the vehicle. The processor determines from a speed look-up table which colored speed indicator light is associated with the present speed. The processor then activates the associated speed indicator light. An identical mini-sized auxiliary unit may be positioned in the vehicle cabin to serve as a self-monitoring aid (i.e., to help a following driver compare his/her own speed with that of a lead vehicle).

The speed indicator lights (and auxiliary mini unit) may make the identification of high-speed, reckless drivers easier because traveling at high speed will activate rearward colored lights that denote those higher speeds and those lights are visible to following and surrounding drivers. Furthermore, any time a speed range is reached and the corresponding colored light is activated, that colored light remains illuminated for as long as the speed is maintained and may be visible from as far away as 200 ft. For these reasons, speeding may become a more publicly visible event than it is today.

Therefore, a general object of this invention is to provide a vehicle velocity visual alert system that replaces conventional brake lights with a panorama of lights that are selectively illuminated according to the speed with which a vehicle is traveling.

Another object of this invention is to provide a vehicle velocity visual alert system, as aforesaid, that includes a main visual alert device having a plurality of different colored lights, each associated with a speed range.

Still another object of this invention is to provide a vehicle velocity visual alert system, as aforesaid, that only illuminates the single colored light that is associated with the current speed of the vehicle.

The vehicle velocity visual alert system also includes a distinct rear-facing brake pedal pressure light that reveals an amount of pressure exerted on the pedal at any given time. This feature is discrete and separate from the array of different colored lights and operates independently of speed and in relation only to braking pressure. Moreover, this feature is all-important to the overall system because it serves to make separate and discrete the act of decelerating from the act of bringing a vehicle to a complete halt (and keeping it stationary). The conventional braking system in use today does not disentangle those two messages, as discussed earlier. Moreover, this feature reflects to the following driver the amount of pressure a driver is putting on the brake; whether the pressure applied is heavy in which case the driver is decelerating rapidly or whether the pressure brought to bear is light in which case the vehicle is slowing down moderately. Either way knowing whether to brake rapidly or moderately can be helpful to a following driver with poor visibility if he needs to maintain a constant distance between cars for safety.

The brake pedal pressure light consists of five red horizontal sub-bands (or sub-lights) under the larger red light housing or cover. These sub-bands light up separately and in stepwise fashion from bottom to top as greater pressure is applied. That is to say, if little pressure is exerted, the first band will activate followed by the second (with the first band remaining lit); if pressure is lifted entirely, the inverse occurs and the second band extinguishes before the first. If the heaviest pressure is exerted (i.e., the driver intends to brake as rapidly as possible due to an emergency), then the first, second, third, fourth and fifth bands will light up in that order and remain lit for the duration of the time the pedal is maximally depressed. When the pressure is removed, then the inverse will occur and the fifth band will extinguish followed by the fourth then the third and so on. This signal is featured twice: one at both ends of the array of colored lights.

In another embodiment of this invention, the brake pedal pressure feature would also span horizontally along the top and bottom of the array of colored lights, not just vertically via stepwise activation of sub-bands (as explained here). In the new embodiment, the concept of brake pedal pressure is the same; that is, the more pressure exerted on the brake, more lights are cumulatively activated. However, unlike the present vertical sub-band brake pedal pressure light (explained here), the new embodiment would be displayed horizontally; that is, there would be some five adjacent red lights (e.g., R-R-R-R-R) centered over the top and bottom of the rear speed indicator lights; when the brake is applied lightly, the center light would activate (i.e., RRRRR); as the pressure builds, the center light would come on along with the two flanking lights, making an array of three activated red lights (i.e., RRRRR); with maximum pressure exerted, the center light, along with the two flanking lights and the two ends lights would be activated, making an array of five activated red light (denoting maximum pressure) (i.e., RRRRR). To illustrate this concept, the letter “R” is used to represent a single deactivated red light of the kind mentioned above and an “R” in bold (ie., R) stands for the same red light being activated.

Conversely, as pressure is lifted, the two ends would extinguish first (ie., RRRRR) followed by the two lights surrounding the center (i.e., RRRRR), the center would be last to deactivate (i.e., RRRRR).

A vehicle velocity visual alert system also includes a “stopped” status vehicle feature, which is activated ONLY when the car is completely stationary. This consists of two red lights (one at each end of the speed indicator lights but outside the brake pressure lights) that come on at the same time when the vehicle speedometer reads zero miles per hour AND the car is completely stopped. The stopped red lights can also be activated when the brake pedal pressure is maximally depressed and slows the vehicle to a stationary position. Under these circumstances, it is clear to a following driver that the lead vehicle has exerted maximum pressure on the brake and that the vehicle is no longer in motion.

To summarize thus far, another object of this invention is to provide a vehicle velocity visual alert system, as aforesaid, that includes brake lights having sub-bands that indicate the respective degree of pressure being exerted upon the vehicle's brake pedal.

A further object of this invention is to provide a vehicle velocity visual alert system, as aforesaid, having “stopped” status lights configured to indicate when the vehicle is completely stopped. A still further object of this invention is to provide a vehicle velocity visual alert system, as aforesaid, having a speedometer and brake pedal pressure sensor and “stopped” light system in communication with a processor whose operation is software controlled.

Another object of this invention is to provide a vehicle velocity visual alert system, as aforesaid, having an auxiliary identical but mini-sized visual alert device selectively positioned within the vehicle cabin, to assist the driver in comparing his/her own speed and driving maneuvers with those of the lead or surrounding vehicles.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a motor vehicle of a vehicle velocity visual alert system according to a preferred embodiment of the invention;

FIG. 2 is a perspective view of an interior cabin of the motor vehicle of a vehicle velocity visual alert system;

FIG. 3a is a perspective view of a main alert device of the vehicle velocity visual alert system;

FIG. 3b is a perspective view of an auxiliary alert device of the vehicle velocity visual alert system;

FIG. 4a is a block diagram illustrating the components of the present invention;

FIG. 4b is a block diagram illustrating the configuration of the memory of FIG. 4a; and

FIG. 5 is a flowchart illustrating the programming logic of a vehicle velocity visual alert system according to the present invention.

### DESCRIPTION OF THE PREFERRED EMBODIMENT

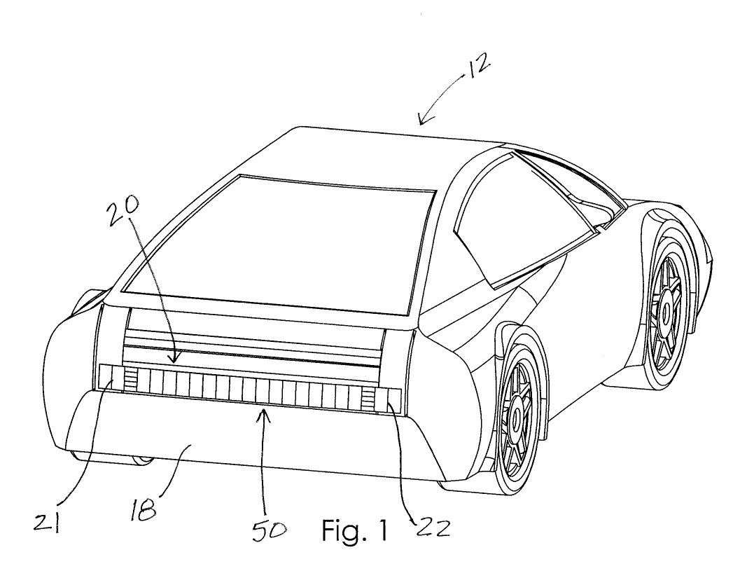

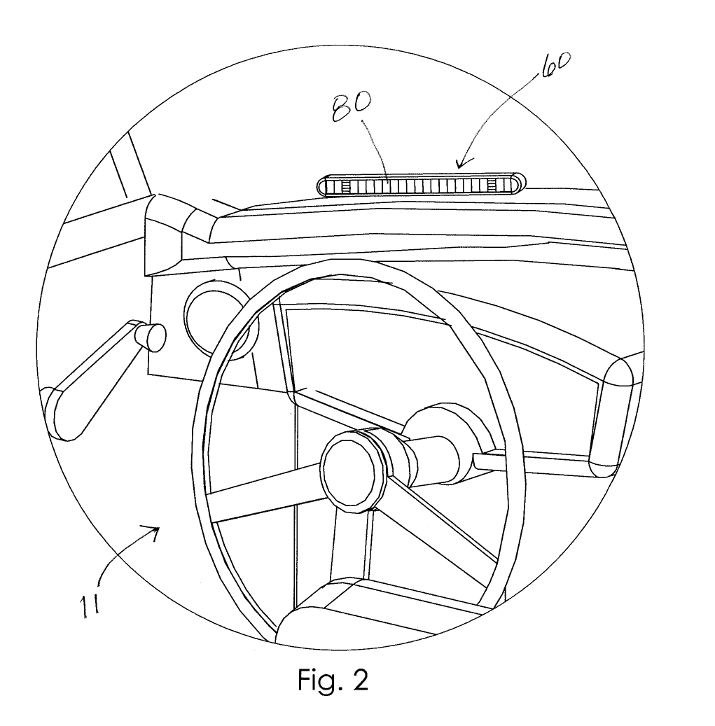

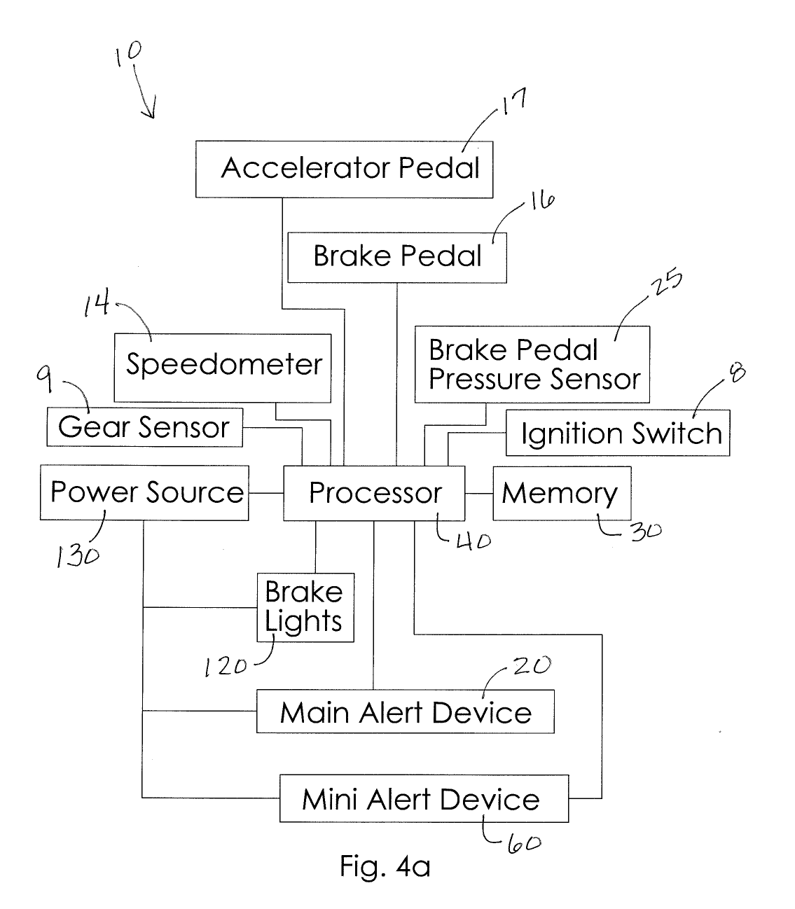

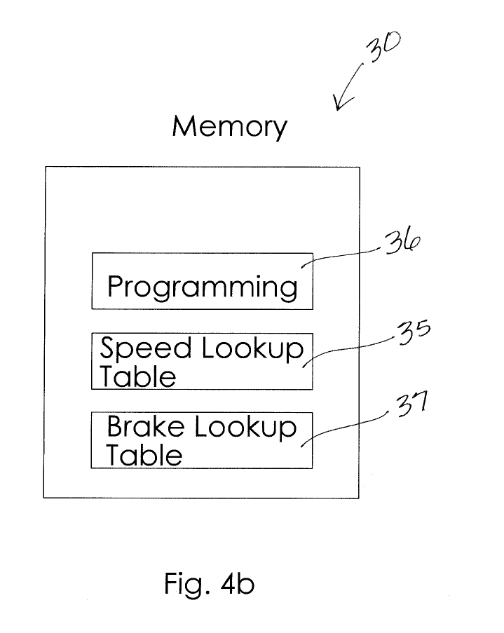

A vehicle velocity visual alert system according to a preferred embodiment of the invention will now be described with reference to FIGS. 1 to 5 of the accompanying drawings. The vehicle velocity visual alert system includes a main alert device (a.k.a. Primary Output Lights) 20 (FIG. 1) which installs on the exterior rear of the vehicle, an auxiliary identical mini alert device (a.k.a. Auxiliary Output Lights) 60 (FIG. 2) which may be positioned in the interior cabin, a memory 30 (FIG. 4a) and a processor 40 (FIG. 4a). The interconnectedness of the memory 30 and the processor 40 to the speedometer 14, the brake pedal pressure sensor 25, and the brake pedal 16 to the primary and auxiliary output lights and more are depicted in FIG. 4a.

The vehicle velocity visual alert system 10 for use with a motor vehicle 12 having a speedometer 14 indicative of a speed at which the motor vehicle 12 is traveling and a brake pedal 16 configured to decrease the speed of the motor vehicle 12. The main alert device 20 includes speedometer 14 that connect a series of side-by-side, speed indicator lights 50 to the accelerator pedal 17. The main alert device 20 may be coupled with and span most of the width of the rear portion/bumper 18 of the motor vehicle 12 and may replace the existing brake lights (not shown) but not the directional indicator lights nor the speed indicator lights 50. A speed indicator light 50 is illuminated when the motor vehicle's speed changes. A change in speed results in the processor activating a respective speed indicator light 50 as will be described more fully below.

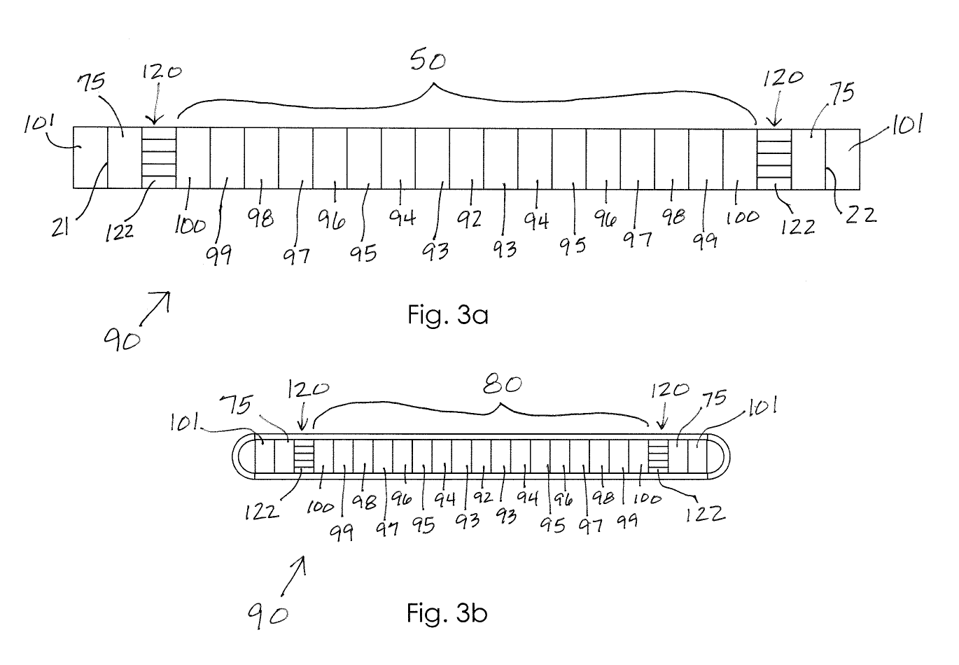

More particularly, the main alert device 20 is mounted to a rear portion 18 of a motor vehicle 12, such as a bumper or trunk lid or even rear window (FIG. 1). The main alert device 20 includes opposed ends 21, 22 and a plurality of speed indicator lights 50 of different colors positioned adjacent to one another between the opposed ends 21, 22 (FIG. 3a). The speed indicator lights 50 are each associated with a respective vehicle speed and are electrically connected to the vehicle speedometer 14. Only the speed indicator lights 50 corresponding to a current speed are illuminated. If the speed changes, the previously illuminated speed indicator light may be extinguished and a speed indicator light associated with the now current speed is energized. In another embodiment (not shown), however, the speed lights may be illuminated cumulatively as the vehicle's speed increases. The preferred embodiment is intended to replace the conventional braking system with speed indicator lights, a brake pressure pedal and a “stopped” status light. It is not intended to eradicate the all important indicator lights. Indicator lights 101 still play an independent role on the rear of any vehicle and, as such, need to be present alongside any embodiment of the invention.

The memory 30 is configured to store programming 36 and data structures such as a speed look-up table 35, which associates predetermined speed ranges with the speed indicator lights 50 of the main alert device 20. It is also configured to store a brake pressure look-up table 37 associating predetermined brake pressure values with corresponding brake pressure indicator lights 120, that are illuminated according to pressure exerted on the brake. The use of these data structures within an operational process will be further described later.

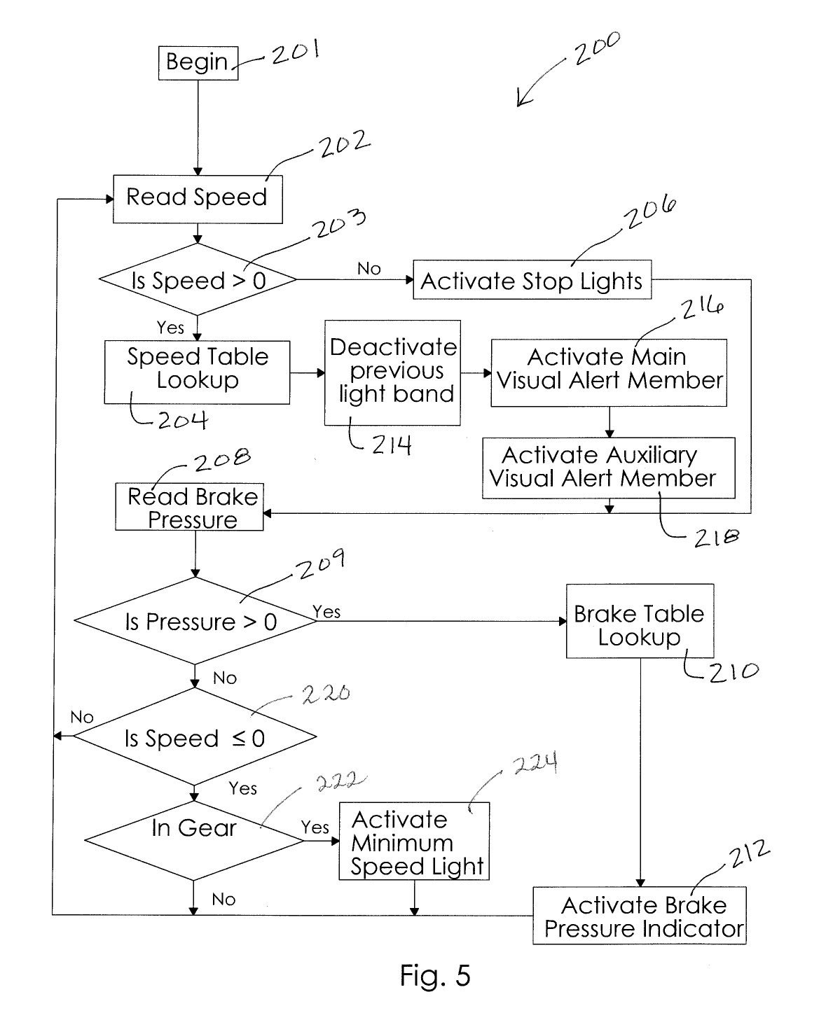

The processor 40 is electrically connected to and in data communication with the memory 30 and is configured to execute the programming 36. The processor 40 is electrically connected to the main alert device 20 to the speedometer 14, and to the brake pressure sensor 25 (FIG. 4a). The programming in the memory 30, when executed by the processor 40, causes the processor 40 to determine the present speed of the motor vehicle 12 from the speedometer 14. Further, the programming causes the processor 40 to determine from the speed look-up table 35 which speed indicator (colored) light 50 is associated with the present speed and should be energized. The programming then causes the processor 40 to energize the matching speed indicator light 50 and its associated colored light-band 90, according to the logic diagram of FIG. 5 as will be further described below.

In some embodiments, the vehicle velocity visual alert system 10 includes an auxiliary visual alert device 60. The auxiliary visual alert device 60 may be selectively positioned in an interior cabin 11 of the motor vehicle 12 or the like (FIG. 2). The auxiliary visual alert device 60 has auxiliary lights 80 so the driver may compare his own speed with that of a driver ahead of him. The auxiliary lights 80 may also be electrically connected to the speedometer 14 although, preferably, they are electrically connected to and may be energized by the processor 40 according to the programming that will be described in detail below. The auxiliary lights 80 of the auxiliary visual alert device 60 are identical to the speed indicator lights 50 of the main alert device 20 although the speed indicator lights 50 may be larger than the auxiliary lights 80. The auxiliary lights 80 and the speed indicator lights 50 include colored light-bands (92-100) as depicted in FIG. 3b. It should be observed that the colored light-bands of the main alert device 20 and of the auxiliary visual alert device 60 are activated using the same reference numerals.

The brake pedal pressure indicator 25 is a sensor electrically connected to the brake pedal 16 and to the processor 40 (FIG. 4a). The brake pedal pressure indicator 25 is activated according to brake pressure and a pair of “stopped” status (red) lights 75 are illuminated if the motor vehicle is completely stationary. The programming may also carry out the conventional functions of motor vehicle braking.

Speed is communicated through the use of distinct colored lights and each colored light corresponds to a different speed range (from 92-100 as seen in FIG. 3a). Examples of actual speed ranges are 61 mph-70 mph and 51 mph-60 mph.

An activated light blue light 95 denotes that a motor vehicle 12 is moving from 51 mph-60 mph and an energized dark green light 96 indicates the motor vehicle 12 is traveling between 41 mph-50 mph. In this scenario, the colored light bands 90 and the predetermined speed ranges work together in the following way. If a vehicle 12 (equipped with the velocity visual alert system 10) is moving at 55 mph, the rear driver will see the dark light blue 95 illuminated. However, if that vehicle 12 increases speed to 62 mph (or any speed up to 70 mph), the following driver will see the dark blue light 94 band activate and the light blue light 95 extinguish.

The colored light-bands 90 are arranged in a specific order, making their position along the speed light system 50 AND color important. The actual array of colored light-bands 90 may include a single violet (V) light 92 band at the very center. The proposed order (moving outward from the center) is purple (P) 93, dark blue (DB) 94, light blue (LB) 95, dark green (DG) 96, light green (LG) 97, yellow (Y) 98, orange (O) 99 and pink (PK) 100. As you move outward from the center, the next light is to appear on both sides of the center light and then on both sides of the prior array. The following array of letters illustrates the display using the proposed order of colors:
PK-O-Y-LG-DG-LB-DB-P-V-P-DB-LB-DG-LG-Y-O-PK
   There may be any number of colored light-bands 90, although the final number may vary depending on how many predetermined speed ranges are ultimately designated.

A brake pedal pressure light 120 (made up of 5 discrete horizontal red sub-bands 122) is to sit at both ends of the speed light system (preferably positioned adjacent ends 21 and 22, respectively, of the main alert device 20). The purpose of this pair of lights is to reflect to the following driver the extent to which the lead vehicle's brake pedal is pressed as it is occurring. The 5 red sub-bands light up from the bottom of the top of the horizontal array in cumulative or stepwise fashion meaning the more pedal pressure is exerted the more sub-bands become activated and, conversely, the less pedal pressure the fewer sub-bands light up. Their role is to subsume what conventional brake lights do only when a vehicle is decelerating.

In addition, a stopped status red light 75 is to be placed at both ends of the main alert device 20, on the outside of each brake pedal pressure light 120. The purpose of this pair of lights is to show without equivocation that the vehicle is completely stationary. It should be observed that if the stop status lights are activated, none of the speed indicator lights 90 should be illuminated, although it is possible for the brake pedal pressure sensor 25 to be fully activated at this time. It would not follow that the brake pedal pressure light 120 would be less than fully activated because the brakes need to be fully engaged, in order to achieve a complete stop. The role of these lights subsumes what conventional brake lights do when a vehicle is completely stationary.

Broadly speaking, the single violet light-band 92, purple light-bands 93, and dark blue light-bands 94 reflect higher speed ranges; the light blue light-bands 95, the dark green light-bands 96, the light green light-bands 97 reveal moderately high speeds and the yellow light-bands 98, the orange light-bands 99, and the pink light-bands 100 display slower, in-city driving and near-stopping speeds. Preferably, the numerical values of the predetermined speed ranges will not be imprinted on the exterior housing of the colored light-bands 90. Drivers may need to memorize which predetermined speed ranges are represented by the colored light band 90. This is straightforward since drivers already associate red, yellow, amber and orange with stopping or slowing down. The colored light-bands 90 represent the predetermined speed ranges as follows:

Violet (V) light-band 92=80+ mph
Purple (P) light-bands 93=71 mph-80 mph
Dark Blue (DB) light-bands 94=61 mph-70 mph
Light Blue (LB) light-bands 95=51 mph-60 mph
Dark Green (DG) light-bands 96=41 mph-50 mph
Light Green (LG) light-bands 97=31 mph-40 mph
Yellow (Y) light-bands 98=21 mph-30 mph
Orange (O) light-bands 99=11 mph-20 mph
Pink (PK) light-bands 100=>0-10 mph
It should be noted that the center light band is Violet and that the rest of the lights appear in a specific sequence as described earlier (i.e., PK 0-Y-LG-DG-LB-DB-P-V-P-DB-LB-DG-LG-Y-O-PK).

Each colored light-band 90 may consist of a single clear light bulb covered by a plastic casing or cover of the designated color to reflect its corresponding speed range. For example, a clear light bulb may be covered by a purple casing to display a 71 mph-80 mph speed range. Just as a brake light appears red from the rear portion 18 of a motor vehicle 12 because its plastic casing is red, so will each colored light-band 90 show as a different color because of the different colored plastic casings. The colored light-bands 90 are in the colors discussed previously and an array of colored lights in the sequence described above spans the length of the main alert device 20. It is understood that the processor 40 manages the activation or de-activation of the respective light-bands under program control and by being in data communication with the brake pedal sensor 25. It should be further noted that the identical mini version of the velocity visual alert system 10 includes all of the same aforementioned elements.

To deflect driver criticism that this system may too readily tip off Highway Patrol Police about speeding drivers because of its capability to reveal speed, careful consideration has gone into how the predetermined speed ranges are grouped together. As such, national speed limits have been nestled within larger predetermined speed ranges. For example because the speed limit in many developed areas is 25 mph, 21 mph to 30 mph was chosen as a predetermined speed range. That is to say, the colored light-band 90 will not automatically illuminate when the speed of the motor vehicle 12 reaches 25 mph; rather the driver must exceed 30 mph before the next light band illuminates (showing 31 mph-40 mph). This concept is not without fault, however, because speed limits differ across jurisdictions and, as such, they may not lend themselves to such convenient handling. It should further be noted that the velocity visual alert system is not designed to hide or to surrender speeding motorists. Drivers will still need to be mindful of their speed and the highway patrol vigilant about enforcing speed restrictions. An interesting byproduct of the velocity visual alert system is, however, that a specific colored light-band 90 can potentially be visible to more drivers, for longer periods of time and over greater distances than ever before. It is hoped that this will result in increased road safety through greater driver awareness.

Consideration has been given by the vehicle velocity visual alert system 10 to the frequency of color blindness in the population in relation to the placement of the different colored light-bands as well as the choice of colored lights on the speed indicator lights 50 and the auxiliary output lights 80. By way of background, as many as 1 in 12 males is afflicted with color blindness and they typically cannot discern red and green from other colors. Despite this specific incapacity, these drivers are arguably as skilled as their non-color blind counterparts. They may well make up for their inability by detecting the activation of a light and discerning its color from its placement in relation to other lights. In the case of universal traffic lights where the sequence is red (for “Stop”), amber (for “Get Ready to Stop”) and green (for “Go), a driver might well detect the activation of a light and decipher it is RED because it is placed at the very top of the vertical trio. Based on this principle, the placement of the different colored light-bands in relation to other colors and to the speed range that they represent has been given special attention.

FIG. 4b is a block diagram illustrating the components of the memory 30 of the vehicle velocity visual alert system 10. A speed look-up table 35 (relating predetermined speed ranges with the speed indicator lights 50 of the main alert device 20) is stored in a respective data structure associated with the memory 30. Similarly, a brake pressure look-up table 37 is stored in memory 30 and includes data that associates brake pressure sensor readings with the degree of illumination of the brake pressure indicator lights 120 (or more particularly, 122). Further, there is programming 36 stored in the memory 30 that, when executed by the processor 40, operates a vehicle velocity visual alert system 10. It is programming in the memory 30 that causes the processor 40 to determine a present speed of the motor vehicle 12 from the speedometer 14. Similarly, it is programming 36 in the memory 30 that causes the processor 40 to determine from the speed table 35 which speed indicator light 50 is associated with the present speed and to energize the matching speed indicator light 50. The power source 130 may be an electrical outlet (not shown) or battery, such as an automotive battery (not shown).

FIG. 5 illustrates an exemplary process 200 carried out by the programming in memory 30 that, when executed by the processor 40, operates the vehicle velocity visual alert system 10. The process 200 may be initiated at step 201, such as when the vehicle is started or at another time at the user's determination. At step 202, the processor determines a current speed of the automobile by reading the vehicle's speedometer 14. This value may be stored in memory 30. A provision would need to be made for automatic vehicles that begin to move as soon as the brake pedal is lifted but the accelerator pedal 17 has not yet been pressed. At step 203, the processor 40 determines if the speed determined from reading the speedometer 14 is greater than 0 (>0). If it is, the process 200 continues to step 204. If it is not, the process 200 continues to step 206 where the processor 40 activates the stopped status lights 101. After the stopped status lights 75 are activated, control is passed to step 208. At step 208, the processor 40, under program control, reads a value from the brake pedal pressure sensor 25 and then proceeds to step 209. At step 209, the processor 40 determines if the brake pedal pressure is greater than 0. If it is, the process 200 proceeds to step 210 so as to access the brake table look-up. If it is not, the processor 40 returns to step 202 and the process 200 starts over. It should be understood that, if the stopped status lights 75 are activated at step 206 and the brake pressure is less than or equal to showing zero pressure (i.e. brake pedal is not being pushed at all), it is likely that the vehicle is in park, has been disengaged, or is somehow idling and stationary while in gear or neutral.

Returning to step 204, the processor 40 now retrieves data from the speed look-up table 35 in memory 30 associating predetermined speed ranges with the speed indicator lights 50 of the main alert device 20. Specifically, the processor 40 determines from the speed look-up table 35, the light-band 90 that is associated with the current speed of the vehicle. The process 200 then proceeds to step 214. At step 214, the processor 40 deactivates the light band currently illuminated that is associated with the previous “current speed”. In other words, the light-band in the main or auxiliary visual light devices 20, 60 must be extinguished so that a light-band associated with the latest speedometer reading can be illuminated. After step 214, the process 200 proceeds to step 216, where the processor 40 will activate respective speed indicator lights 50 associated with the current speed of the vehicle 12 as it changes. After step 216, the process 200 proceeds to step 218, where the processor 40 will activate auxiliary lights 80. In another embodiment, the process 200 may proceed to step 216 and 218 simultaneously. It is understood that, if the current speed is within the same speed range as the previous current speed, the respective light-band may remain activated or it may be sequentially deactivated and reactivated.

After step 218, the process 200 proceeds to step 208, where the processor 40 will read the brake look-up table 37 from the memory 30. At step 208, the processor 40 executes programming to determine if the brake pedal sensor 25 indicates pressure on the brake pedal 16 that is greater than 0 (i.e., if there is any pressure on the brake pedal at all). If the processor 40 determines that the brake pressure is not greater than zero, then the process 200 proceeds to step 202 and the process 200 essentially begins again by reading the current speed of the vehicle as indicated by the speedometer 14. If, however, the processor 40 determines the brake pressure is greater than zero, then the process 200 proceeds to step 210. At step 210, the processor 40 accesses the brake pressure look-up table 37 stored in memory 30 to determine how the brake pressure lights 120 are to be displayed. The process 200 then proceeds to step 212, at which time the processor 40 energizes the brake pressure lights 120 according to the determination at step 210. Energizing the brake pressure lights 120 involves, illuminating one or more or all of the horizontal red light sub-bands 122 as described above. After step 212, the process 200 proceeds to step 202, at which time the process 200 essentially begins again.

In one embodiment, the alert system 10 may include an ignition switch sensor 8 and an engine gear engagement sensor 9. The system may also include programming capable of sensing when the engine ignition switch has been actuated (i.e. the engine is turned on) and when the vehicle has been placed in gear. Programming instructions may also be included to determine a circumstance when a vehicle's engine has been started, has been placed into gear, the brake pedal released, but the accelerator pedal 17 has not yet been pressed. This is the situation where the vehicle may be rolling slowly but not fast enough to cause a respective speed light to be activated. In this circumstance, the processor 40 will energize the lowest speed indicator light. These conditions are shown graphically in FIG. 5 at steps 220, 222, and 224.

It is understood that the illumination of the speed lights of the main alert device 20 must reflect the current vehicle speed and brake pedal pressure at any given time. This means that the speed lights and brake pedal pressure lights are in continuous operation. For this reason, the processor 40 may repeat the process 200 thousands of times per second.

It is further understood that, while certain forms of this invention have been illustrated and described, it is not limited thereto, except insofar as such limitations are included in the following claims and allowable functional equivalents thereof.

1. A vehicle velocity visual alert system for use with a motor vehicle having a speedometer configured to indicate a speed at which the motor vehicle is traveling and a brake pedal configured to decrease the speed of the motor vehicle when depressed, comprising:
a main alert device mounted to a rear portion of the motor vehicle, said main alert device having opposed ends and including a plurality of speed indicator lights positioned adjacent to one another between said opposed ends;
an auxiliary visual alert device selectively positioned in an interior cabin of the motor vehicle to which said main alert device is mounted, said auxiliary visual alert device having opposed ends and a plurality of auxiliary speed indicator lights being positioned adjacent to one another between said opposed ends;
a memory configured to store programming and data structures, said data structures including a speed look-up table associating predetermined speed ranges with respective speed indicator lights of said main alert device and with respective auxiliary speed indicator lights of said auxiliary visual alert device, wherein each of said predetermined speed ranges corresponds to a colored light band;
a processor electrically connected to said memory and configured to execute said programming, said processor being electrically connected to said main alert device and said auxiliary visual alert device and to the speedometer;
programming in said memory that when executed by said processor causes said processor to determine from the speedometer a present speed of the motor vehicle; and
programming in said memory that when executed by said processor causes said processor to determine from said speed look-up table which indicator light is associated with said present speed; and programming in said memory that when executed by said processor causes said processor to energize said associated speed indicator light and said associated auxiliary speed indicator light.

2. (canceled)

3. The vehicle velocity visual alert system as in claim 1, further comprising a brake pedal pressure sensor electrically connected to the brake pedal and to said processor that is configured to indicate a degree of pressure being received by the brake pedal, said main alert device including a plurality of brake indicator lights and a pair of “stopped” status lights; said brake indicator lights being activated according to said brake pressure sensor and said “stopped” status lights being energized if a speed of the speedometer of the motor vehicle is equal to zero.

4. The vehicle velocity visual alert system as in claim 3, further comprising:
programming that when executed by said processor causes said processor to determine from said brake pedal pressure sensor a current brake pressure being applied to the brake pedal; programming in said memory that when executed by said processor causes said processor to determine from said brake pressure look-up table which brake indicator light is associated with said current brake pressure; and
programming in said memory that when executed by said processor causes said processor to energize said associated brake indicator light.

5. The vehicle velocity visual alert system as in claim 4, further comprising a pair of brake pedal pressure light-bands that are subdivided into smaller equal-sized horizontal red light sub-bands that are configured to represent said current brake pressure.

6. The vehicle velocity visual alert system as in claim 5, wherein said red light sub-bands are energized sequentially and cumulatively as brake pressure on the brake pedal is increased and are extinguished in reverse order as brake pressure is decreased.

7. The vehicle velocity visual alert system as in claim 1, wherein said predetermined speed ranges are 80+ mph, 71 mph-80 mph, 61 mph-70 mph, 51 mph-60 mph, 41 mph-50 mph, 31 mph-40 mph, 21 mph-30 mph, 11 mph-20 mph, >0-10 mph.

8. The vehicle velocity visual alert system as in claim 1, wherein said colored light-bands include a violet light-band, a pair of dark blue light-bands, a pair of light blue light-bands, a pair of dark green light-bands, a pair of light green light-bands, a pair of yellow light-bands, a pair of orange light-bands, a pair of pink light-bands and blends thereof.

9. A vehicle velocity visual alert system for use with a motor vehicle having a speedometer indicative of a speed at which the motor vehicle is traveling and a brake pedal configured to decrease the speed of the motor vehicle, comprising:
a main alert device mounted to a rear portion of the motor vehicle, said main alert device having opposed ends and including a plurality of speed indicator lights positioned adjacent to one another between said opposed ends;
an auxiliary visual alert device selectively positioned in an interior cabin of the motor vehicle to which said main alert device is mounted, said auxiliary visual alert device having opposed ends and a plurality of auxiliary speed indicator lights being positioned adjacent to one another between said opposed ends;
a brake pedal pressure sensor electrically connected to the brake pedal and to said processor that is configured to indicate a degree of pressure being applied to the brake pedal, said main alert device including a plurality of brake indicator lights and a “stopped” status light, said brake indicator lights being activated according to said brake pressure sensor and said “stopped” status lights being energized if the speedometer of the motor vehicle indicates a speed equal to zero;
a memory configured to store programming and data structures, said data structures include a speed look-up table associating predetermined speed ranges with respective speed indicator lights of said main alert device and with said auxiliary speed indicator lights of said auxiliary alert device and a brake pressure look-up table associating predetermined brake pressure values with respective brake indicator lights;
a processor electrically connected to said memory and configured to execute said programming, said processor being electrically connected to said main alert device and to the speedometer;
programming in said memory that when executed by said processor causes said processor to determine from the speedometer a present speed of the motor vehicle;
programming in said memory that when executed by said processor causes said processor to determine from said speed look-up table which speed indicator light and which auxiliary speed indicator light is associated with said present speed; and
programming in said memory that when executed by said processor causes said processor to energize said associated speed indicator light and said associated auxiliary speed indicator light.

10. The vehicle velocity visual alert system as in claim 9, wherein said predetermined speed ranges each corresponds to a colored light-band.

11. The vehicle velocity visual alert system as in claim 10, wherein said predetermined speed ranges are 80+ mph, 71 mph-80 mph, 61 mph-70 mph, 51 mph-60 mph, 41 mph-50 mph, 31 mph-40 mph, 21 mph-30 mph, 11 mph-20 mph, >0-10 mph.

12. The vehicle velocity visual alert system as in claim 10, wherein said colored light-bands include a violet light-band, a pair of dark blue light-bands, a pair of light blue light-bands, a pair of dark green light-bands, a pair of light green light-bands, a pair of yellow light-bands, a pair of orange light-bands, a pair of pink light-bands and blends thereof.

13. The vehicle velocity visual alert system as in claim 10, wherein each colored light-band has a clear light bulb and a plastic casing, said plastic casing being one of the violet light-band, a pair of dark blue light-bands, a pair of light blue light-bands, a pair of dark green light-bands, a pair of light green light-bands, a pair of yellow light-bands, a pair of orange light-bands, a pair of pink light-bands and blends thereof.

14. The vehicle velocity visual alert system as in claim 9, further comprising:
programming that when executed by said processor causes said processor to determine from said brake pedal pressure sensor a current brake pressure being applied to the brake pedal; programming in said memory that when executed by said processor causes said processor to determine from said brake pressure look-up table which brake indicator light is associated with said current brake pressure; and
programming in said memory that when executed by said processor causes said processor to energize said associated brake indicator lights.

15. The vehicle velocity visual alert system as in claim 9, wherein said main alert device includes a pair of brake pedal pressure light-bands that are subdivided into smaller equal-sized horizontal red light sub-bands and configured to represent said current brake pressure.

16. The vehicle velocity visual alert system as in claim 15, wherein said red light sub-bands are energized sequentially and cumulatively when said brake pressure sensor indicates pressure on the brake pedal is increased and are extinguished in reverse order when said brake pressure sensor indicates pressure on the brake pedal is decreased.

17. A method for visually alerting surrounding drivers to the velocity and braking status of a motor vehicle having an ignition switch sensor, a gear engagement sensor, a speedometer configured to indicate a speed at which the motor vehicle is traveling, and a brake pedal configured to decrease the speed of the motor vehicle when depressed, said method comprising the steps of:
providing a main alert device mounted to a rear portion of the motor vehicle, said main alert device including a plurality of speed indicator lights positioned adjacent to one another and a plurality of brake pressure indicator lights;
providing a brake pedal pressure sensor electrically connected to the brake pedal, said brake pedal pressure sensor configured to detect an amount of pressure being exerted upon the brake pedal;
providing an auxiliary alert device having a plurality of auxiliary speed indicator lights, a plurality of brake pressure indicator lights, and a pair of “stopped” status lights, said auxiliary alert device being configured to be positioned inside a cabin area of the vehicle to which said main alert device is mounted;
determining from the speedometer a current speed of the motor vehicle;
energizing a respective speed indicator light and a respective auxiliary speed indicator light associated with said current speed if said current speed is greater than zero;
determining a current brake pressure detected by said brake pedal pressure sensor; and
energizing a respective brake pressure indicator light associated with said current brake pressure; and
wherein said main alert device includes a pair of “stopped” status lights at opposed ends of said main alert device and adjacent to said plurality of brake pressure indicator lights, said method further comprising the steps of:
determining if the brake pressure of the motor vehicle is equal to zero; and
energizing said pair of “stopped” status lights if said current speed is equal to zero.

18. (canceled)

19. The method for visually alerting according to claim 17, further comprising de-energizing respective speed indicator lights not associated with said current speed.

20. (canceled)

21. The method of visually alerting according to claim 17, wherein each said speed indicator light includes a light-band having a color different from a color of any other light-band, each light-band color being associated with a speed range.

22. The method of visually alerting according to claim 17 wherein said main alert device includes a pair of brake pedal pressure light-bands that are subdivided into smaller, equal-sized horizontal red light sub-bands and configured to represent said current brake pressure.

23. The method for visually alerting as in claim 22, wherein said red light sub-bands are energized sequentially and cumulatively when said brake pressure sensor indicates pressure on the brake pedal is increased and are extinguished in reverse order when said brake pressure sensor indicates pressure on the brake pedal is decreased.

24. The method of visually alerting as in claim 22, wherein said “stopped” status lights are activated only when vehicle speedometer is at zero.

25. The method of visually alerting as in claim 17, further comprising:
determining if the ignition switch sensor is indicative of the vehicle having been started;
determining if the gear engagement sensor is indicative of the vehicle being in gear;
determining is said brake pressure is equal to zero; and
energizing a respective speed indicator light associated with a minimal speed if said current speed is equal to zero, said break pressure is equal to zero, said ignition sensor is indicative of the vehicle being started, and said gear engagement sensor is indicative of the vehicle being in gear.
